(19) United States
(12) Patent Application Publication
(10) Pub. No.: US 2010/0087103 A1
(43) Pub. Date: Apr. 8, 2010

(54) ELECTRICAL TERMINATION

(75) Inventors: Donald F. DECKER, Harrisburg, PA (US); Pete DESANTIS, Harrisburg, PA (US); Gary D. PORTA, Shiremanstown, PA (US); Edward J. HOWARD, Millersburg, PA (US); Thomas G. SCHWARTZ, Harrisburg, PA (US)

Correspondence Address: TYCO TECHNOLOGY RESOURCES, 4550 NEW LINDEN HILL ROAD, SUITE 140, WILMINGTON, DE, 19808-2952, US

(73) Assignee: TYCO ELECTRONICS CORPORATION, Berwyn, PA (US)

(21) Appl. No.: 12/244,507

(22) Filed: Oct. 2, 2008

(51) Int. Cl. H01R 4/10; H01R 43/042

(52) U.S. Cl. 439/877; 29/751

(57) ABSTRACT

A crimped wire termination is disclosed for electrically terminating thereto a stainless steel wire. The termination includes a barrel having a concave spine and opposing fingers on either end of the spine extending outwardly from the spine at symmetrical angles. The fingers are adapted to encircle an end of a wire. An indentation formed in the spine when crimped. The indentation forms a segment of the barrel having a cross-sectional diameter less than a cross-sectional diameter of an adjacent end of the barrel, and forms a bend in the wire at opposite ends of the segment, to prevent axial movement through the barrel.

The present disclosure is directed to an electrical termination device and method, and more particularly to an electrical termination for stainless steel wire with a formed brass terminal.

### BACKGROUND

Stainless steel wire may be used in some applications for conducting electrical signal. For example, in energized surgical instruments such as high-frequency (HF) cauterizing devices with which incision of a living body tissue or hemostasis is performed by using a high-frequency current, the surgical instrument may include stainless steel wire for conducting high frequency signals. Stainless steel wire is generally more suitable for sterilization of medical instruments than other conductive metals such as copper and aluminum. Stainless steel wire has a high tensile strength and high resistance to penetration, or hardness. Stainless steel wire is further characterized by spring properties that resist bending and deformation. Such properties make it difficult to apply a mechanical termination to the wire, because the inherent spring properties and hardness of the wire prevents deformation of the wire that is necessary to ensure reliable mechanical and/or electrical connections in other, more malleable or ductile conductive metals. Ductile metal wires may be easily attached to a termination device such as a connector pin or socket, because the malleability of the wire permits it to be compressed together by a crimping device into a mechanical joint that enables suitable contact for a permanent electrical connection.

When used in electroconductive applications, stainless steel wire is currently terminated by welding or fusing an end of the stainless steel wire to a connecting pin formed of the same or similar metal. Welding forms a reliable electrical connection between stainless steel wire and termination devices such as connector pins and sockets. Welding the wire terminations, however, requires complex equipment that is costly to install and maintain, and which consumes high amounts of energy when in operation, thus making the terminated wire connections expensive and time consuming to manufacture.

What is needed is a mechanically crimped electrical termination that provides reliable electrical connection to a stainless steel wire.

### SUMMARY OF THE DISCLOSURE

In one embodiment, the disclosure is directed to a crimped wire termination for electrically terminating a stainless steel wire thereto. The termination includes a barrel having a concave spine and opposing fingers on either end of the spine extending outwardly from the spine at symmetrical angles. The fingers are adapted to encircle an end of a wire. An indentation formed in the spine when crimped. The indentation forms a segment of the barrel having a cross-sectional diameter less than a cross-sectional diameter of an adjacent end of the barrel, and forms a bend in the wire at opposite ends of the segment, to prevent axial movement through the barrel.

In another embodiment, the disclosure is directed to a device for crimping a ductile metal termination to a stainless steel wire: (a) an anvil; and (b) a crimping tool movable relative to the anvil for crimping a sleeve therebetween. The anvil includes a top edge having a tooth portion projecting upward from a portion of top edge for forming an indentation in the ductile metal termination, and a sharp edge disposed along each side of opposing sides of tooth portion the sharp edges formed by a concave horizontal profile of the top edge. The sharp edges provide sharp edges on opposing sides of the top edge are for engaging the ductile metal of barrel. The crimping tool includes a rectangular metal plate with a bell shaped mouth that tapers into a slot, the slot terminating in an m-shaped end portion. The anvil cooperates with the crimping tool to form a crimped connection between the termination and the wire when the termination and wire are forced under pressure by the anvil in contact with the crimp tool.

In another embodiment, the disclosure is directed to a method of crimping an open-barrel type crimp termination on an end of a stainless steel wire, wherein the crimp termination includes a barrel having a concave spine and opposing fingers on either end of the spine, the fingers extending outwardly at acute angles from a centerline of the spine, and the fingers adapted to encircle an end of a wire; and an indentation formed in the spine opposite the encircled wire when crimped; the indentation forming a segment of the barrel having a cross-sectional diameter less than a cross-sectional diameter of an adjacent end of the barrel, and forms a bend in the wire at opposite ends of the segment, to prevent axial movement through the barrel. The method includes placing an open barrel of the open-barrel type crimp termination adjacent an end of the stainless steel wire on a stationary anvil, the anvil having a tooth extending upwardly from a top surface of the anvil in contact with the spine; and displacing a crimping tool toward the anvil under pressure and bending the fingers approximately symmetrically around the wire and forming a bend in the wire at each adjacent end of the barrel.

Other features and advantages of the present disclosure will be apparent from the following more detailed description of the preferred embodiment, taken in conjunction with the accompanying drawings which illustrate, by way of example, the principles of the disclosure.

### BRIEF DESCRIPTION OF THE DRAWINGS

FIG. 1 is a top view of a crimp connection in accordance with the present disclosure.

FIG. 2 is a cross-sectional view of the crimp connection taken along the lines 2-2 in FIG. 1.

FIG. 3 is a perspective view of an exemplary anvil used for crimping the connection.

FIG. 4 is a partial elevational view of an exemplary crimp tool and anvil crimping a barrel on a wire.

FIG. 5 is a cross-sectional view of the barrel before crimping.

FIG. 6 illustrates top view of an exemplary embodiment of a termination having a pin formed at one end of the termination.

### DETAILED DESCRIPTION OF THE DISCLOSURE

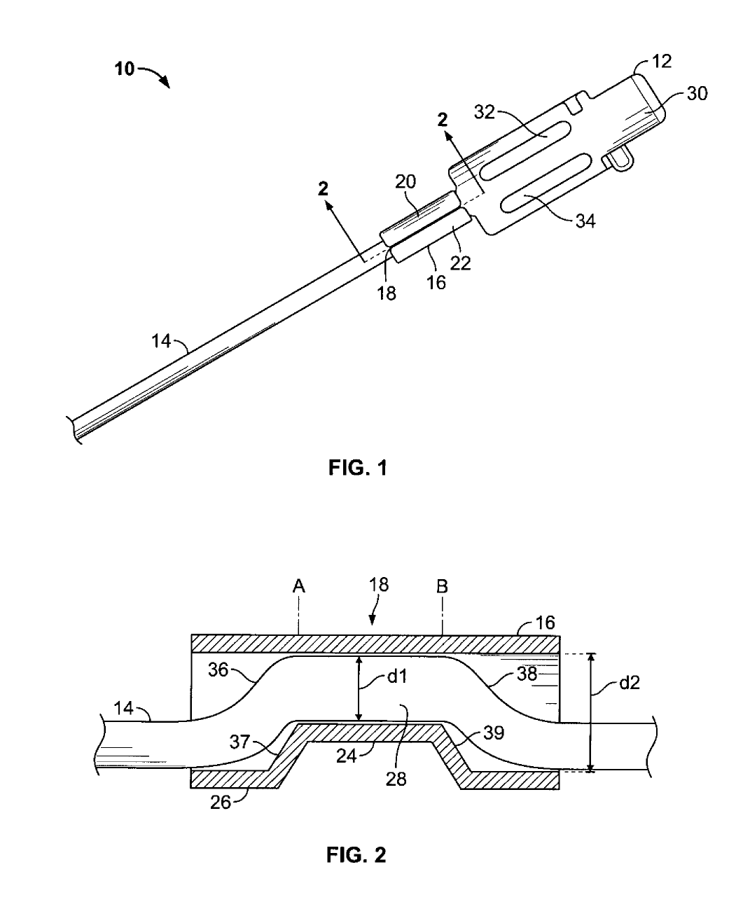

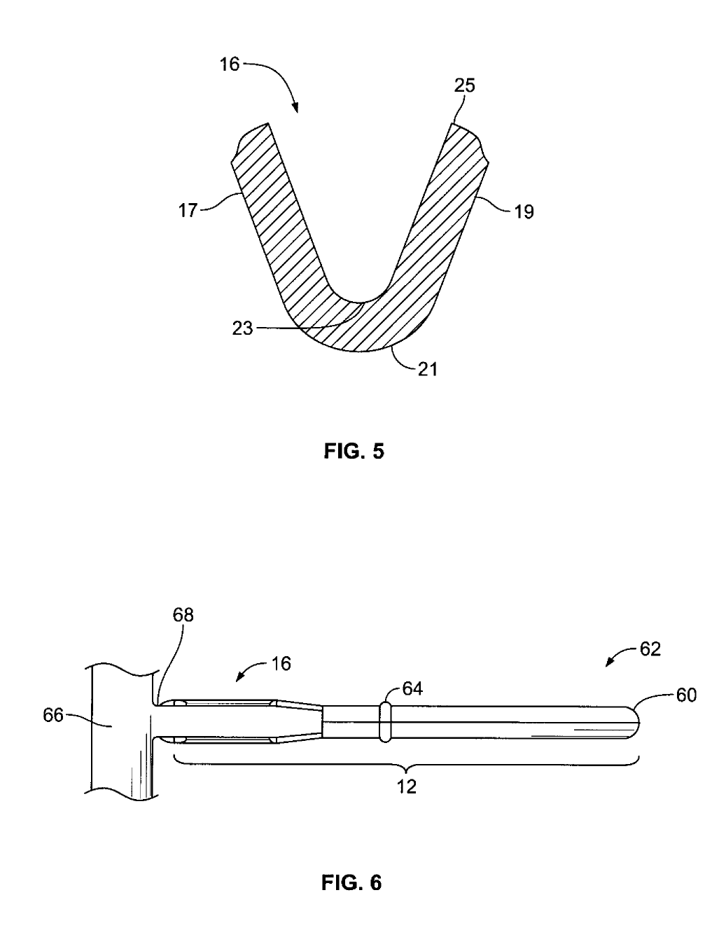

Referring to FIG. 1, an exemplary embodiment of a crimped connection 10 is shown in accordance with the present disclosure. The connection 10 includes a termination 12 attached to a wire 14 by a wire barrel 16. Wire barrel 16 may be integrally formed on one end of the termination 12. Wire barrel 16 has a semicircular or V-shaped cross section and a pair of fingers 17 and 19 (FIG. 5) integrally extending at opposing acute angle from ends of a spine 21 (FIG. 5) located in a circular arc 23 (FIG. 5) of the barrel 16 and adapted with sharpened edges 25 (FIG. 5) or other features suitable for engaging the surface of wire 14 as the fingers 17, 19 are crimped on wire 14. Termination 12 is shown as a generally flat spade portion 30 with embossments 32, 34 which increase the strength of termination 12 and stabilize the spade portion in its housing; however, termination may take any shape of electrical connector that can receive a wire. In one embodiment, wire 14 may be formed from any grade of stainless steel, stainless steel alloy or other electrically conductive metal having a high tensile strength, and the termination 12 and barrel 16 may be formed from brass or other, more ductile alloys relative to wire 14. The barrel 16 is formed around wire 14 by means which are described below. A seam 18 is formed on one side of the barrel 16 by axially opposing rolled edges 20, 22.

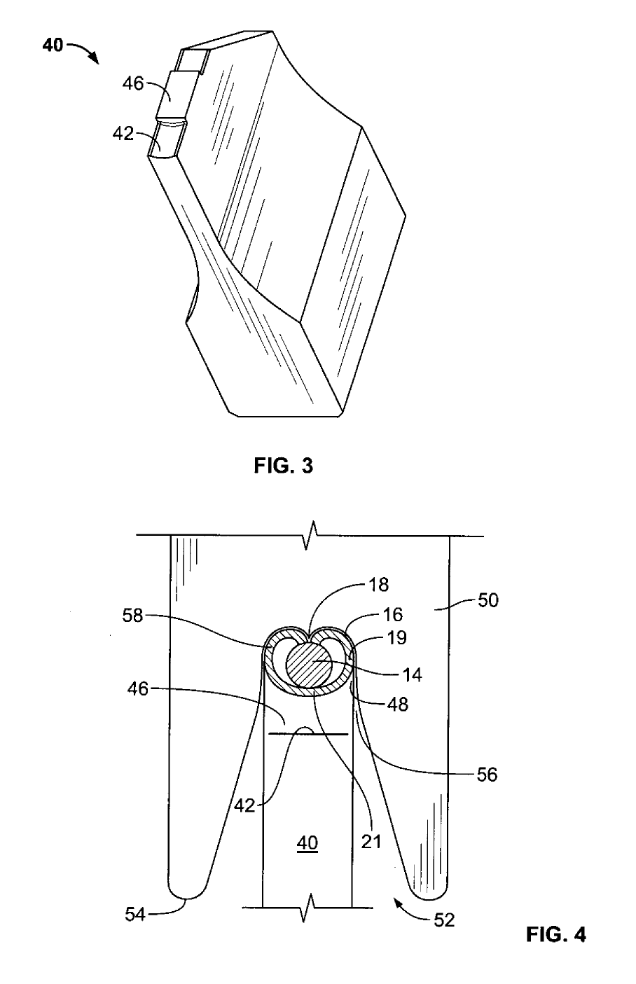

Referring next to FIG. 2, a cross-sectional view taken along the axis of barrel 16 is shown after crimping. Wire 14 extends axially through the full length of barrel 16. An indentation 24 is formed along a side 26 of barrel 16 opposite seam 18. Indentation 24 is formed by an anvil 40 (FIG. 3) and crimp tool 50 (FIG. 4). When wire 14 is inserted in the open V-section of barrel 16 and barrel 16 and wire 14 are crimped between anvil 40 and crimp tool 50, bends 36, 38 are formed in wire 14 at point A and at point B, respectfully. The hollow cross section of barrel 16 is more ductile than wire 14, and is thus compressed by the anvil 40 in the crimping tool 50 to tightly form around wire 14 along the segment 28 defined by points A-B, with the barrel 16 having an inner diameter d1 between segments A-B that is approximately the same as the diameter of wire 14. On either end of barrel 16 outside of segment A-B, the inner diameter d2 of barrel 16 is greater than inner diameter d1. The wire bends 36, 38 abut transition walls 39, 37, respectively that are disposed in barrel 16 where inner diameter d1 transitions to inner diameter d2. Transition walls 37, 39 prevent axial movement of wire 14 within barrel 16, preventing removal of wire 14 from termination 12. Barrel 16 maintains electrical continuity between wire 14 and termination 12.

Referring next to FIG. 3, an anvil 40 has a top edge 42 with a tooth portion 46 projecting upward from a portion of top edge 42 for forming the indentation 24. The tooth portion 46 may be disposed approximately at the middle of top edge 42. Top edge 42 may have sharp edges 48 along either side of projecting portion 46, the sharp edges 48 formed by a concave horizontal profile to provide sharp edges on opposing sides of top edge 42 for piercing into the ductile metal of barrel 16. Anvil 40 cooperates with a crimp tool 50 (FIG. 4) to form the crimped connection 10. In one embodiment anvil 40 may be formed from a metal having ductile strength and tensile strength comparable to that of the metal forming wire 14. In other embodiments (not shown) anvil 40 may include two or more projecting portions 46 for forming multiple indentations 24.

Referring next to FIG. 4, crimp tool 50 is arranged to receive barrel 16 and anvil 40 to form a rolled seam 18 on a top side of barrel 16, and an indentation 24 on an opposite side of barrel 16. Crimp tool 50 is a rectangular metal plate with a bell shaped mouth 52 on one side 54. Mouth 52 tapers into a slot 56. Slot 56 terminates in an m-shaped end portion 58. Barrel 16 has an open V-shaped profile (FIG. 5) before being crimped. Each finger 17, 19 of the open V-shaped profile are inserted first into the slot 56 and urged against the end portion 58, with the spine 21 of the V-shape facing towards mouth 52. In crimping barrel 16 of the crimp termination 12, crimp tool 50 and anvils 40 are used. Specifically, wire 14, and if wire 14 has insulation, the insulation end (not shown) are respectively introduced into barrel 16. Barrel portions are placed between crimp tool 50 and anvil 40 which are opposed to each other in the vertical direction. Then the crimp tool 50 is lowered to crimp fingers 17, 19 between the crimp tool 50 and anvil 40, to thereby crimp the barrel 16 and termination 12 on an end of wire 14.

As shown in FIG. 4, in a crimping method for the fingers 17 and 19 the wire barrel portion would have fingers 17 and 19 curving inwardly and down to engage wire 14 while contacting respective tip ends of the fingers 17 and 19 with each other. Because of the relative hardness of wire 14 compared to the more ductile barrel 16, fingers 17, 19 do not pierce the surface of wire 14, but are deformed in contact with wire 14 in the crimping process to provide a friction fit against wire 14 in the elongated portion of wire 14. The bends 36, 38 in wire 14 in the crimped area cause wire 14 to have a smaller diameter within the segment 28 than the diameter of the remaining length of wire 14 and prevent axial movement of wire 14 through barrel 16 to maintain wire 14 within barrel 16.

FIG. 6 illustrates an exemplary embodiment of a termination having a pin 60 formed at one end 62 of the termination 12 opposite barrel 16. A locking collar 64 is formed intermediate end 62 and barrel 16, for locking pin 60 in a plastic housing (not shown). Barrel 16 is attached to a continuous carrier strip 66. Carrier strip 66 is an elongated metal strip that a plurality of terminations 12 detachably connected to carrier strip 66 by a narrow junction strip 68 extending outward approximately perpendicular to the carrier strip 66 so that terminations 12 can be produced and stored on reels in quantities and fed through an automated crimping machine (not shown). Although a pin-style connector (FIG. 6) and a spade-style connector (FIG. 1) are illustrated herein, it is understood that any termination configuration may be formed integrally with barrel 16.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A crimped wire termination for electrically terminating a stainless steel wire thereto, the termination comprising:
a barrel having a concave spine and opposing fingers on either end of the spine extending outwardly from the spine at symmetrical angles, the fingers adapted to encircle an end of a wire; and
an indentation formed in the spine;
wherein the indentation forms a segment of the barrel having a cross-sectional diameter less than a cross-sectional diameter of an adjacent end of the barrel, and forms a bend in the wire at opposite ends of the segment, to prevent axial movement through the barrel.

2. The termination of claim 1, wherein the barrel is integrally formed with a termination portion.

3. The termination of claim 1, wherein the termination is a male or female connector.

4. The termination of claim 1, wherein the barrel and termination have greater ductility than the wire.

5. The termination of claim 4, wherein the barrel further comprises a pair of opposing fingers integrally extending at an acute angle from a spine disposed in a circular arc of the barrel.

6. The termination of claim 5, wherein the each opposing finger of the pair of opposing fingers includes a sharpened edge suitable for engaging the surface of wire when the fingers are crimped on the wire.

7. The termination of claim 1, wherein the termination comprises a spade portion and interlocking features disposed on the spade portion.

8. The termination of claim 1, wherein the wire may be formed from a material selected from the group consisting of stainless steel, stainless steel alloy, and electrically conductive metals having a high tensile strength.

9. The termination of claim 8, wherein the barrel may be formed from brass or other ductile alloys relative to the wire.

10. The termination of claim 5, wherein the barrel 16 is formed around the wire and a seam is formed on one side of the barrel by crimping the opposing fingers.

11. The termination of claim 1, wherein the barrel is more ductile than the wire and compressible by an anvil when placed in a crimping tool to form the barrel around the wire along a crimped segment of the barrel, the barrel having an inner diameter in the crimped segment that is approximately the same diameter as the diameter of the wire.

12. The termination of claim 11, wherein each wire bend at opposite ends of the segment abuts a transition wall disposed in barrel where a first inner diameter of the barrel transitions to a second inner diameter of the barrel, the transition walls prevent axial movement of the wire within the barrel to prevent removal of the wire from the termination.

13. The termination of claim 2, further comprising a pin disposed at an end of the termination portion opposite the barrel.

14. The termination of claim 13, further comprising a locking collar disposed intermediate the pin and the barrel, the locking collar configured to lock the pin in a plastic housing.

15. The termination of claim 2, further comprising a continuous carrier strip for detachably connected to a plurality of terminations, the barrel attached to the continuous carrier strip by a narrow junction strip, the continuous carrier strip configured for continuously feeding the plurality of terminations through an automated crimping machine to produce crimped wire terminations.

16. A device for crimping a ductile metal termination to a stainless steel wire: (a) an anvil; and (b) a crimping tool movable relative to the anvil for crimping a sleeve therebetween;
the anvil comprising:
a top edge having a tooth portion projecting upward from a portion of top edge for forming an indentation in the ductile metal termination, and a sharp edge disposed along each side of opposing sides of tooth portion the sharp edges formed by a concave horizontal profile of the top edge, the sharp edges providing sharp edges on opposing sides of top edge for engaging the ductile metal of barrel;
the crimping tool comprising:
a rectangular metal plate with a bell shaped mouth that tapers into a slot, the slot terminating in an m-shaped end portion;
wherein the anvil cooperates with the crimping tool to form a crimped connection between the termination and the wire when the termination and wire are forced under pressure by the anvil in contact with the crimp tool.

17. The device of claim 16, wherein the tooth portion is disposed approximately at the middle of the top edge.

18. The device of claim 16, wherein the anvil and the crimping tool are comprised of a metal having ductile strength and tensile strength approximately equal to the ductile strength and tensile strength of the wire.

19. A method of crimping an open-barrel type crimp termination on an end of a stainless steel wire wherein the open barrel type crimp termination has a barrel having a concave spine and opposing fingers on either end of the spine extending outwardly at acute angles relative to a centerline of the spine, the fingers adapted to encircle an end of a wire; and an indentation formed in the spine opposite the encircled wire when crimped; the indentation forming a segment of the barrel having a cross-sectional diameter less than a cross-sectional diameter of an adjacent end of the barrel, and forms a bend in the wire at opposite ends of the segment, to prevent axial movement through the barrel, the method comprising:
placing an open barrel of the open-barrel type crimp termination adjacent an end of the stainless steel wire on a stationary anvil, the anvil having a tooth extending upwardly from a top surface of the anvil in contact with the spine; and
displacing a crimping tool toward the anvil under pressure and bending the fingers approximately symmetrically around the wire and forming a bend in the wire at each adjacent end of the barrel.

20. The method of claim 16, wherein the step of bending the fingers includes curving the fingers inwardly and down to engage wire while contacting respective tip ends of the fingers with the opposing tip end of the opposing finger.
